(19) United States
(12) Patent Application Publication
(10) Pub. No.: US 2011/0314048 A1
(43) Pub. Date: Dec. 22, 2011

(54) SOCIAL NETWORK USER LIST DETECTION AND SEARCHING

(75) Inventors: Steven W. Ickman, Snoqualmie, WA (US); Thomas M. Laird-McConnell, Kirkland, WA (US); Lili Cheng, Bellevue, WA (US)

(73) Assignee: Microsoft Corporation, Redmond, WA (US)

(21) Appl. No.: 12/820,616

(22) Filed: Jun. 22, 2010

(51) Int. Cl. G06F 15/16; G06F 17/30

(52) U.S. Cl. 707/769; 709/204; 707/E17.014; 707/802; 707/E17.044

(57) ABSTRACT

Within a social network, users may define user lists comprising users who share a semantic nexus. The creation and updating of user lists may be detected by monitoring the messages of users to detect list identifiers (e.g., names) indicating new user lists, and by polling the social network to detect changes in the membership of respective user lists. The list identifiers may be recorded in the user profiles of respective members of the user lists. Moreover, when a user posts a message to the social network, the message may be annotated with the list identifiers recorded in the user profile of the user. These techniques may permit the restriction of a search query over messages to those posted by members of a particular user list, e.g., by searching for messages having annotations that match the list identifiers of the user lists specified in the search query.

### BACKGROUND

A social network comprises a set of users with a set of relationships thereamong that may reflect real-world relationships, such as familial or friend relationships; business, school, and community associations; and one-way relationships, such as fandom. Within such a social network, a user may generate a message, such as a status comprising current news about the user or a textual, audio, and/or video note about a particular topic, and may indicate that this message may be shared with other users. Additionally, a user may create a user list, comprising a set of users that the owner of the list considers related in some way. For example, a user may generate a first user list named “Family” comprising (as members of the user list) other users who have familial relationships with the user, a second user list named “Friends” comprising as members a set of users who have friendship relationships with the user, and a third user list named “Weblogs” comprising as members several other users whose weblogs the user regularly views. A user list may be owned by one or more owners, who may maintain the user list by adding users as members, removing members, or sending messages to the members of the user list.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the capability of creating and maintaining user lists may be advantageous to users, some limitations may exist in performing particular operations involving such user lists. A user may wish to detect and be notified when other users create user lists, or when the owners of such user lists update the user lists by adding or removing members of the user list. A user may also wish to search for messages posted by members of the list; e.g., a user may be interested in a particular product, and may seek comments about the product by searching for any messages posted by members of the user's “Friends” user list that include the name of the product. However, the social network may not provide suitable interfaces for these tasks. For example the social network may be configured to provide information about a particular user list upon request of a user (e.g., by enumerating the members of a particular user list specified by a list identifier, such as the name of the user list), but may not provide an event subscription mechanism for identifying the creation or updating of a user list, and/or may be incapable of restricting a search query to the messages posted by members of a particular user list.

Techniques for tracking the creation and generation of user lists and related tasks (such as applying a search query to messages of members of a particular user list) may be devised that address these capabilities. It may be observed that when a user generates a user list, the user may post a message about the user list in order to advertise the availability of the user list to other users. Therefore, it may be possible to detect the generation of user lists by monitoring the messages of various users to identify and extract list identifiers (such as the names of user lists.) If the list identifier has not previously been detected, it may be determined that the list identifier identifies a new user list, and the social network may be queried to identify the members of the new user list. The social network may then be polled at a desired frequency to identify updates to the user list. Additionally, the tracking of the user list may be utilized in related operations. For example, when a user generates a new message, the message may be annotated with the list identifiers of the user lists that include the user as a member. This annotation may facilitate the searching of messages; e.g., a search query may be restricted to messages posted by members of one or more user lists by including the list identifiers in the search query, and then applying these list identifiers during the search to the annotations of the messages, thereby producing as search results only messages that have been annotated with the corresponding list identifiers. These and other advantages may be achievable through the techniques of user list detection and monitoring that are presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a social network comprising representations of users and relationships thereamong.

FIG. 2 is an illustration of an exemplary scenario featuring a social network featuring user lists comprising a subset of users as members.

FIG. 3 is an illustration of an exemplary scenario featuring a detection of user lists in a social network through the monitoring of messages.

FIG. 4 is an illustration of an exemplary scenario featuring the detection of updates of user lists in a social network through the polling of the user lists.

FIG. 5 is an illustration of an exemplary scenario featuring a search query restricted to a user list and applied to a set of messages by annotating messages with list identifiers of the user lists of the author of the message.

FIG. 6 is a flow chart illustrating an exemplary method of identifying user lists comprising at least one member within a social network having user profiles of respective users.

FIG. 7 is a component block diagram illustrating an exemplary system for identifying user lists comprising at least one member within a social network having user profiles of respective users.

FIG. 8 is an illustration of an exemplary computer-readable medium comprising processor-executable instructions configured to embody one or more of the provisions set forth herein.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a social network, comprising a set of users who may form relationships thereamong. Such relationships may represent two-way relationships, such as family relationships, friend relationships, acquaintance relationships, business relationships such as colleagues, academic relationships such as fellow students and instructor/student relationships, and community relationships. Such relationships may also represent one-way relationships, such as authors, musicians, and public figures whom a particular user wishes to follow. These relationships may be formed in the real world, online outside of the social network, or even within the social network (such as two users of the social network who meet each other by having mutual relationships with a third user within the social network.) Among such users, the social network may permit many forms of communication. For example, a user may send a private message to another user, such as an instant message or an email message. A user may also post a message that may be viewable by other users (e.g., viewable only by users having a relationship with the author of the message, publicly viewable by any user of the social network, or globally viewable even by individuals who are not represented in the social network.)

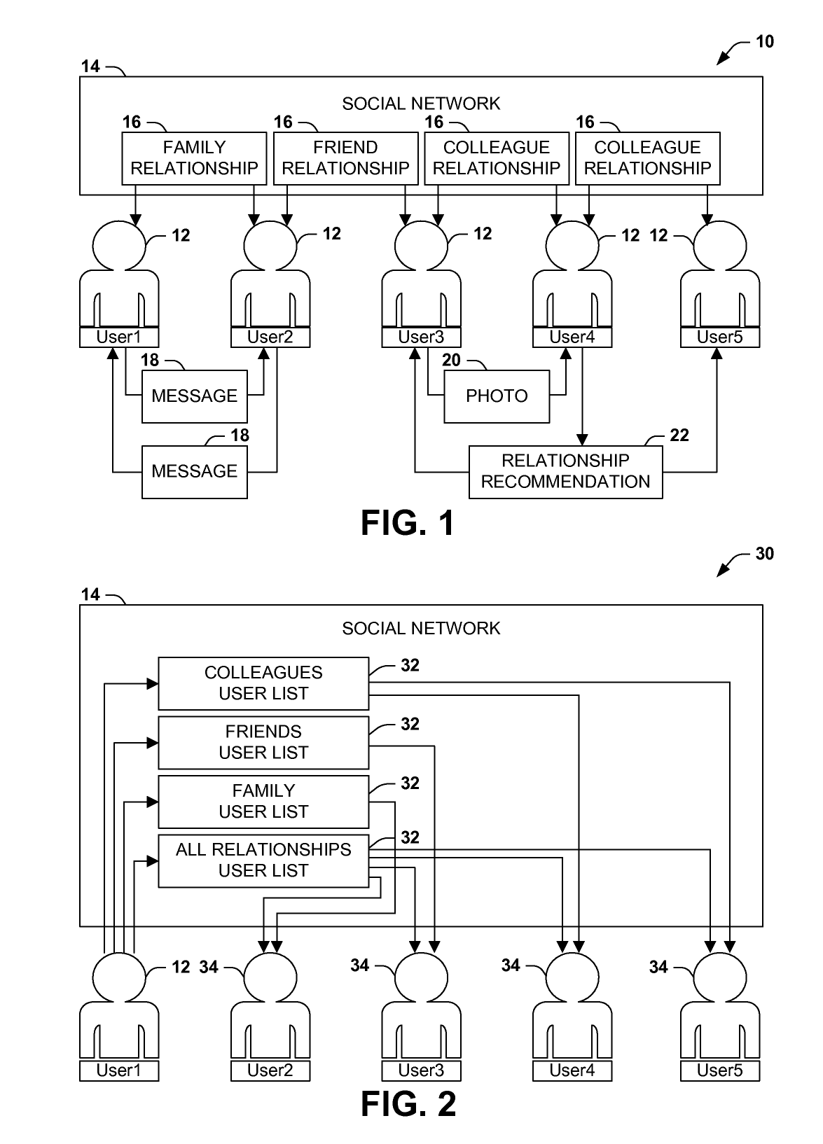

FIG. 1 presents an illustration of an exemplary scenario 10 featuring a set of users 12 represented in a social network 14, and having various relationships 16 within the social network 14. For example, a first user may have a family relationship with a second user, who has a friend relationship with a third user, who has a colleague relationship with a fourth user, who has a colleague relationship with a fifth user. The users 12 of this social network 14 may engage in various activities, such as sending messages 16 to each other, posting media such as photos 20 for viewing by other users 12, and providing relationship recommendations 22 to each other (e.g., the fourth user may recommend that the third user and the fifth user form a colleague relationship, as both are colleagues of the fourth user.) The relationships 16 represented among the users 12 of this social network 14 may provide useful information to other users (e.g., a first user may view a list of users who have relationships with a second user), but may also affect the sharing of messages (e.g., the photo 20 posted by the third user might be viewable only by users 12 who have a relationship 16 with the third user.) In this manner, a social network 16 may utilize the relationships 16 among users 12 to promote networking among users 12.

A particular aspect of social networks 14 involves the formation of a user list, where a user 12 may generate a list of other users 12 who are semantically related in some way. For example, a user 12 may generate a first user list that includes (as members of the user list) all of the other users 12 who have friendship relationships 16 with the user 12, and a second user list that includes (as members of the user list) all of the other users 12 who have colleague relationships 16 with the user 12. These user lists 12 may be helpful to the user 12 in many ways, such as annotating the other users 12 on behalf of the user 12 (e.g., by allowing a user 12 to identify a set of related users 12 by an arbitrary semantic), by consolidating content (e.g., by presenting a news feed comprising status messages posted by the members of a user list representing a particular community or related to a particular topic), and/or by streamlining communication (e.g., by allowing a user 12 to contact all members of a particular user list with a message 18 that relates to the semantic nexus of the user list.)

FIG. 2 presents an illustration of an exemplary scenario 30 featuring a social network 14 representing a set of users 12 and including a set of user lists 32. In this exemplary scenario 30, a first user 12 creates a set of user lists 32 that include members 34 who are other users 12 having relationships with the first user 12. For example, the first user 12 may generate a first user list 32 named “Colleagues User List” that includes as members 34 all other users 12 who have a colleague relationship 16 with the first user 12 (such as a fourth user 12 and a fifth user 12), a second user list 32 named “Friends User List” that includes as members 34 all other users 12 who have a friendship relationship 16 with the first user 12 (such as a third user 12), and a third user list 32 named “Family User List” that includes as members 34 all other users 12 who have a family relationship 16 with the first user 12 (such as a second user 12.) The first user 12 may also create a fourth user list 32 named “All Relationships User List” that includes as members 34 all other users 12 with whom the first user 12 has any type of relationship 16. Another user list 32 that might be included in such an exemplary scenario 30 include, e.g., a “Weblog Authors User List” that identifies all users 12 who generate weblogs that the first user 12 enjoys viewing; this user list 32 may be useful, e.g., for requesting the social network 14 to generate and present to the first user 12 all of the weblog articles written by the members 34 of this user list 32, thereby aggregating the first user's selected weblogs into a single content feed. Conversely, a user 12 who is an author of content might generate a user list 32 comprising all of the users 12 who enjoy viewing the content authored by the user 12, which may be useful, e.g., for contacting all members 34 in the manner of a mailing list. These and other user lists 32 may be generated and utilized within the context of a social network 14.

However, within social networks 14 supporting user lists 32, limitations may arise relating to the architecture of the social network 14. For example, the social network 14 may provide an interface for submitting queries about a particular user list 32 and receiving information, such as an enumerated list of users 12 who are members 34 of the user list 32, but it may be difficult to identify new user lists 32, such as receiving notifications of the creation of a user list 32. It may also be difficult to detect updates to a user list 32, such as the addition of new members 34 or the removal of previously added members 34. Further capabilities may be missing from the support by the social network 14 of user lists 32, such as the capability of applying a search query to messages 18 written by the members 34 of a particular user list 32. For example, a user 12 may wish to determine if any other users 12 who have friendship relationships 16 with the user 12 are attending a particular event, such as a conference. The user 12 may therefore wish to apply a search query (using the name of the event as a keyword) to all messages 18 posted by members 34 of a “Friends” user list 32, but the social network 14 may not be configured to support this type of restriction.

These and other features might be useful to users 12, but may not be implemented by the social network 14. As a first example, the social network 14 might endeavor to implement a publication/subscription mechanism to notify users 12 of the creation or updating of new user lists 32; but such user lists 32 may be created and updated so frequently that notifying a large number of subscribing users 12 of all changes may prohibitively exhaust the computing resources (such as database access capacity, processor availability, and network bandwidth) of the social network 14. As a second example, in order to restrict a keyword-type search query to a user list 32, the social network 14 might first identify the member 34 of the user list 32, and then might apply the search query to the messages 18 generated by each member 34 of the user list 32. This processing task might involve several accesses of databases comprising the infrastructure of the social network 14, which may unsustainably consume the resources of such databases, particularly if several user lists 32 are named, and/or if the user lists 32 comprise many members 34. Based on these and other considerations, the social network 14 may be unable to offer these features of user lists 32, or the administrators of the social network 14 may simply choose not to implement such resource-intensive features in order to allocate the resources of the social network 14 to features of greater perceived value to users 12.

However, techniques may be devised to implement these features of user lists 32 atop simpler features of the social network 14. Presented herein are techniques for detecting the creation of user lists 32 and the updating of user lists 32, in addition to other features, such as the capability of restricting a search query to messages 18 authored by members 34 of a particular list 32. These techniques may be implemented using the currently available infrastructure of the social network 14, and/or may be implemented with greater efficiency of computing resources than may be achievable by other techniques.

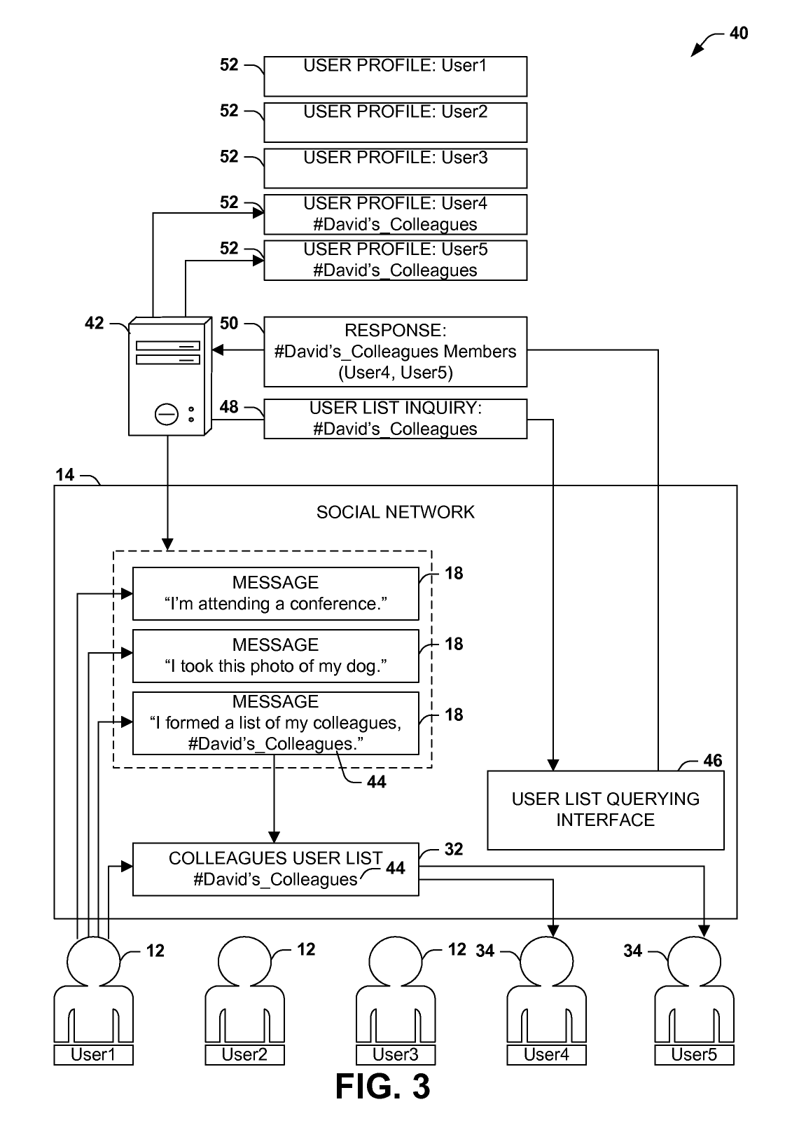

A first such technique relates to the detection of the creation of a new user list 32. FIG. 3 presents an illustration of an exemplary scenario 40 featuring a social network 14 operated by a set of users 12 who may create one or more user lists 32, each of which may have a distinctive list identifier 44, such as a distinctive name, number, or keyword. In this exemplary scenario 40 and others presented herein, the list identifiers 44 of various user lists 32 are distinctively identified by a hash symbol preceding an text string, such as “#David's_Colleagues”. As further illustrated in this exemplary scenario 40, the social network 14 may implement a user list querying interface 46, such as a web service that may be invoked with a list identifier 44 to retrieve an enumerated list of members 34 of the specified user list 32, but which might not offer a mechanism for notifying a user 12 of the creation of new user lists 32.

In the exemplary scenario 40 of FIG. 3, it may be observed that when a user 12 creates a new user list 32, the user 12 may write a message 18 regarding the creation of the user list 32 in order to notify other users 12 of the user list 32. For example, the user 12 may generate a user list 32 of weblog authors who the user 32 finds interesting and may wish to share this user list 32 with other users 12, and so may post a message 18 describing and identifying the user list 32. It may be possible to configure a device 42 to monitor the messages 18 of the social network 14, and in particular to evaluate the contents of various messages 18 in order to detect list identifiers 44 in the message 18 of the first user 12 according to the formatting convention (i.e., the use of the hash symbol preceding a text string to identify a new user list 32.) Upon detecting the list identifier 44 in the message 18, the device 42 may determine whether the list identifier 44 has been previously detected; and if not, the device 42 may deduce that the list identifier 44 identifies a new user list 32. For example, the device 42 may monitor many messages 18 posted by the first user 12 and other users 12, and may detect the list identifier 44 “#David's_Colleagues” as a list identifier 44 of a new user list 32. The device 42 may then send a request 48 to the user list querying interface 46 to enumerate the members 34 of the user list 32, and upon receiving a response 50 from the user list querying interface 46, may use the information in the response 50 to identify the members 34 of the user list 32. For example, the device 42 may have access to a set of user profiles 52 representing respective users 12 of the social network 14 (which may be either stored within the social network 14 or outside of the social network 14, such as by the device 42.) Upon receiving the response 50 from the user list querying interface 46 identifying the members 34 of the user list 32, the device 42 may store with the user profiles 52 of the respective members 34 the list identifier 44 of the new user list 32. In this exemplary scenario 40, the device 42 is notified that the new user list 32 “#David's_Colleagues” created by the first user 12 includes as members 34 a fourth user 12 and a fifth user 12 of the social network 14, and may therefore store in the user profiles 52 of these users 12 the “#David's_Colleagues” list identifier 44 of the user list 32 to which these users 12 belong as members 34. In this manner, the device 42 may monitor the messages 18 of the social network 14 to detect new user lists 32 (e.g., based on the formatting convention of the list identifiers 44 thereof), may query the user list querying interface 46 for more information about the new user list 32, and may store the user list membership information in the user profiles 52 of the members 34 of the user list 32.

A second technique may be devised for monitoring the social network 14 for updates to one or more user lists 32. It may be difficult to track updates to a user list 32, because, in addition to the unavailability of an event notification system from the social network 14, the owner of a user list 32 may be less inclined to post messages 18 about updates to the user list 32 than to post a message 18 about the creation of the user list 32. Therefore, a polling mechanism may be utilized to detect updates to the user list 32.

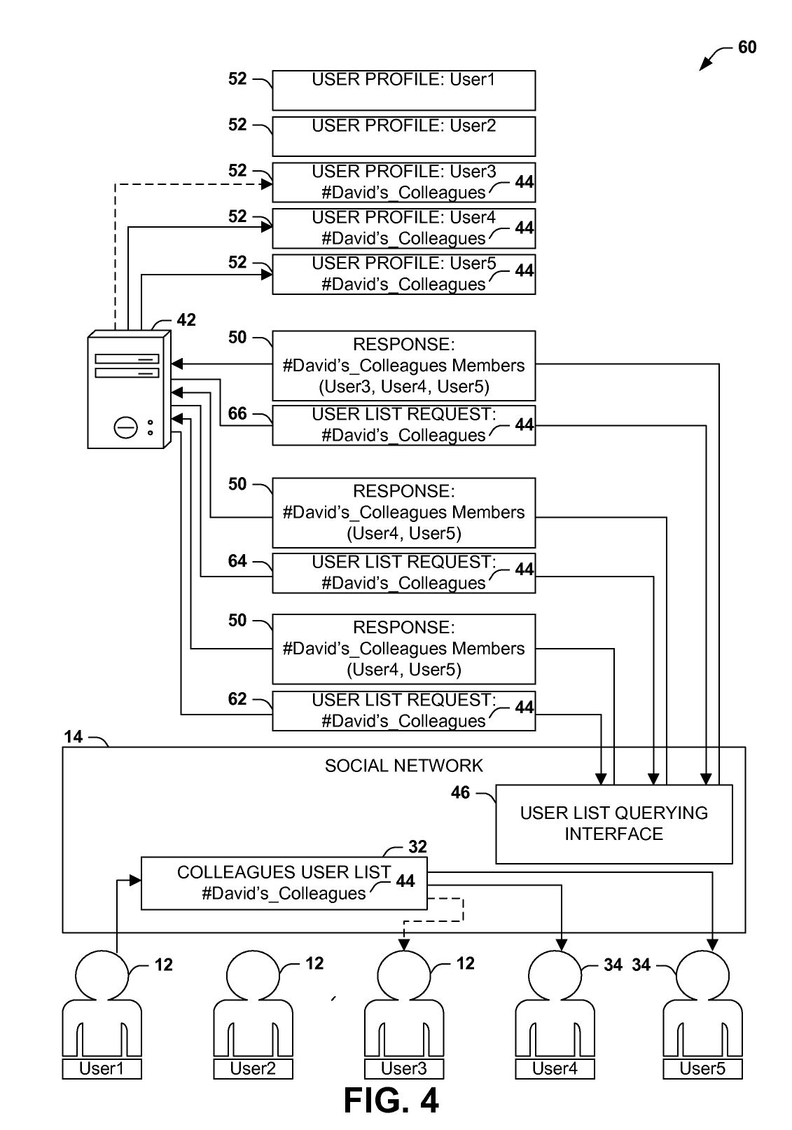

FIG. 4 illustrates an exemplary scenario 60 featuring a polling by a device 42 of the user list querying interface 46 of a social network 14 for updates to one or more user lists 32. In this exemplary scenario 60, a first user 12 has created a user list 32 (having the list identifier 44 “#David's_Colleagues”) that initially includes as members 34 a fourth user 12 and a fifth user 12. The device 42 may have already recorded this information in the corresponding user profiles 52 of these members 34. The device 42 may therefore issue to the user list querying interface 46 a first request 62 for an enumeration of members 34 of the user list 32, and may receive a response 50 indicating the users 12 already known to be members 34 of the user list 32. Subsequently, the device 42 may issue to the user list querying interface 46 a second request 64 for an enumeration of the members 34 of the user list 32, and may receive back the same response 50 indicating no change in the composition of the user list 32. Subsequently, the first user 12 may add a third user 12 as a member 34 of the user list 32; and when the device 42 issues a third request 66, the response 50 may indicate the addition of the third user 12 as a member 34 of the user list 32. Accordingly, the device 42 may update the user profile 52 of the third user 12, e.g., by storing in the user profile 52 the list identifier 44 of the user list 32. In this manner, the device 42 may detect updates to one or more user lists 32, even if the social network 14 does not offer a mechanism for facilitating this detection. Moreover, the polling of the social network 14 by the device 42 may be adjusted to allocate more frequent polling of user lists 32 that are more likely to change; e.g., a polling frequency may be computed for a particular user list 32 based on its age, size, and/or popularity. These and other techniques for monitoring updates of detected user lists 32 are presented herein.

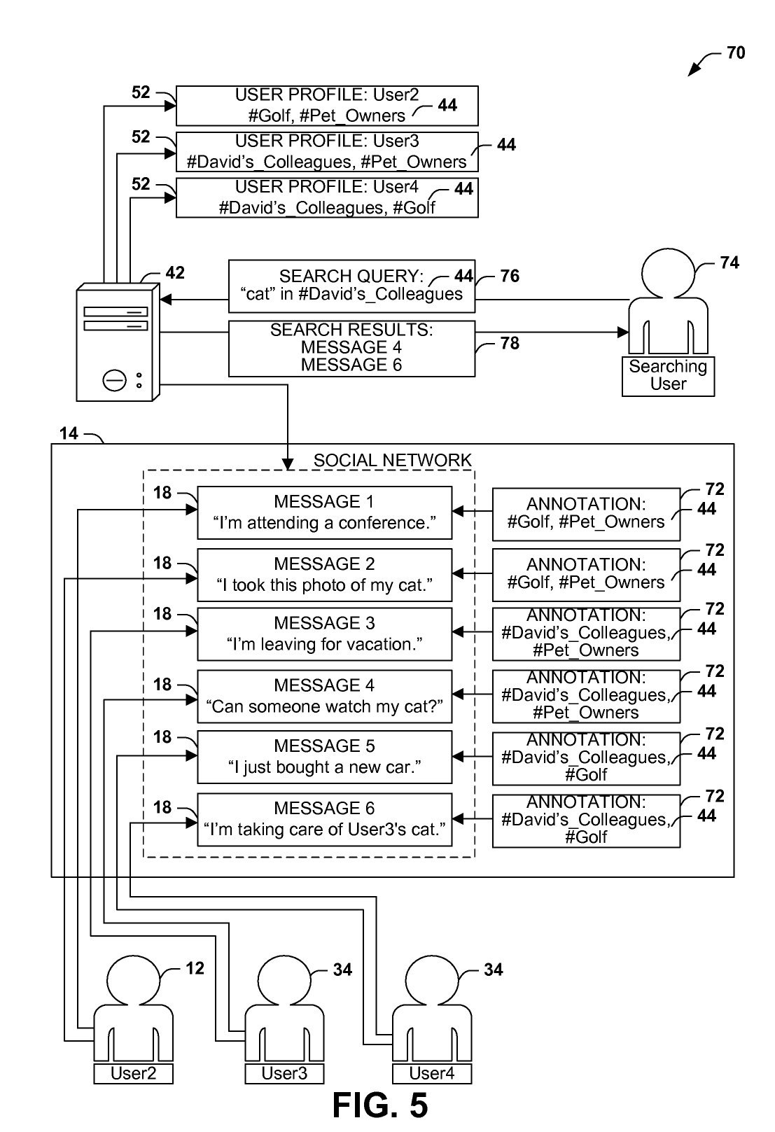

If user lists 32 of the social network 14 may be detected and updated in this manner, additional techniques may also be devised to add features to those provided by the social network 14. For example, it may be feasible to provide a search interface that accepts a search query to be applied to the messages 18 of the social network 14, and to restrict the search query to the messages 18 within a particular user list 32, e.g., those posted by members 34 of the user list 32. FIG. 5 presents an illustration of an exemplary scenario 70 featuring one such technique, wherein a device 42 is configured to interface with the social network 14 in a manner that promotes the restriction of a search query to the messages 18 of members 34 of one or more particular user lists 32. In this exemplary scenario 70, a second user 12 is a member 34 of two user lists 32 identified (via list identifiers 44) as #Golf and #Pet_Owners; a second user 12 is a member 34 of two user lists 32 identified as #David's_Colleagues and #Pet_Owners; and a third user 12 is a member 34 of two user lists 32 identified as #David's_Colleagues and #Golf. These users 18 may each post a series of messages 18 relating to various topics, such as attending a conference, going on vacation, and purchasing a new car. Moreover, pursuant to the techniques illustrated in FIG. 3, a device 42 may have detected the creation of the specified user lists 32, and may have stored in the respective user profiles 52 of the users 12 the list identifiers 44 of the user lists 32 to which the user 12 has been added as a member 34. Additionally, pursuant to the techniques illustrated in FIG. 4, the device 42 may be maintaining the user lists 32 by polling the social network 14 to detect updates to a user list 32, and altering the user profiles 52 of respective users 12 in order to reflect such updates to the user lists 32.

Within the exemplary scenario 70 of FIG. 5, a searching user 74 may wish to apply a search query 76 to the messages 18 of the social network 14, but may only wish to view messages 18 posted by members 34 of a particular user list 32, such as the #David's_Colleagues user list. For example, the searching user 74 may be interested in viewing messages about cats posted by his or her colleagues, but not by other users 12 of the social network 14. While the social network 14 may be capable of performing this search and returning qualifying search results, it may be inefficient for the social network 14 to apply this search query 76 in an ad hoc manner, e.g., by identifying the current members 34 of the one or more user lists 32 specified in the search query 76 and by searching for messages 18 posted by any of these members 34, as this may be a comparatively computationally expensive operation. Rather, the device 42 configured to identify and maintain the user lists 32 may facilitate the application of the search query 76 in the following manner. When a message 18 is received from a user 12, the device 42 may reference the user profile 52 of the user 12 authoring the message 18, may retrieve the list identifiers 44 stored in the user profile 52, and may store these list identifiers 44 with the message 18, e.g., as an annotation 72 of the message 18 indicating the user lists 32 including as a member 34 the user 12 who posted the message 18. This annotation 72 might be overt (e.g., explicitly added to the visible contents of the message 18) or covert (e.g., stored with the message 18 but not visible in the contents of the message 18.) Because this task involves only a single reference to retrieve the list identifiers 44 stored in the user profile 52 of the posting user 12, this operation is likely to impose only a low computational expense. Subsequently, when the searching user 74 submits the search query 76 to be restricted to one or more user lists 32 (e.g., by specifying one or more user identifiers 44 of the user lists 32 to which the search is to be restricted), the device 42 and/or the social network 14 may search for messages that both contain content matching the content of the search query 76, and that include (e.g., as an annotation 72) one or more of the list identifiers 44 specified in the search query 76. For example, in this exemplary scenario 70, the search query 76 may be applied to the messages 18 of the users 12 to identify in the search results 78 the fourth message 18 (authored by the third user 12 as a member 34 of the #David's_Colleagues user list 32) and the sixth message 18 (authored by the fourth user 12 as another member 34 of the #David's_Colleagues user list 32), but not the second message 18 authored by the second user 12 (who is not a member 34 of the #David's_Colleagues user list 32.) By annotating messages 18 upon receipt and applying the search query 76 to these annotations 72, the search may be performed without references to any user list 32, or even to the user profiles 52 of the respective members 34 of the specified user lists 32. The device 42 may therefore provide a user-list-restricted message search without imposing significant computational burdens on the social network 14.

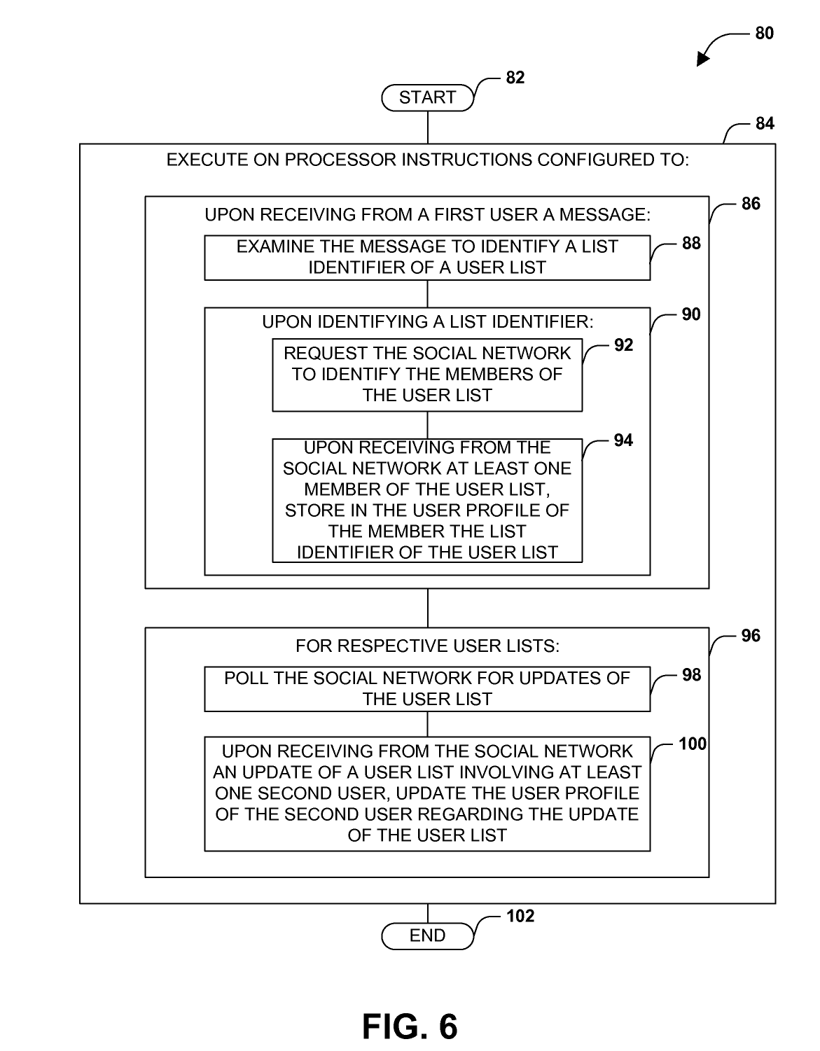

FIG. 6 presents a first embodiment of these techniques, illustrated as an exemplary method 80 of identifying, within a social network 14 having user profiles 52 of respective users 12, where at least one user 12 publishes at least one message 18, a user list 32 comprising at least one member 34. The exemplary method 80 is performed on a device having a processor, such as a workstation, a server, a mobile computer such as a notebook or tablet, or a small mobile such as a mobile phone or a personal data assistant (PDA). The exemplary method 80 begins at 82 and involves executing 84 on the processor instructions configured to perform the techniques presented herein. More specifically, the instructions of the exemplary method 80 are configured to, upon receiving 86 from a first user 12 a message 18, examine 88 the message 18 to identify a list identifier 44 of a user list 32, and upon identifying 90 a list identifier 44 in the message 18, request 92 the social network 18 to identify the members 34 of the user list 32. Moreover, the instructions are configured to, upon receiving 96 from the social network 14 at least one member 34 of the user list 32 (identified in response to requesting 92 the social network 18 to identify such members 34), store 98 in the user profile 52 of the member 34 the list identifier 44 of the user list 32. In this manner, the instructions are configured to detect, enumerate, and store new user lists 32 upon creation by a user 12. The instructions are also configured to, for respective user lists 96, poll 98 the social network 14 for updates of the user list 32, and upon receiving from the social network 14 an update of a user list 32 involving at least one second user 12, update 100 the user profile 52 of the second user 12 regarding the update of the user list 32. Having achieved the detection of both the creation and the updating of user lists 32 of the social network 14, the exemplary method 80 ends at 102.

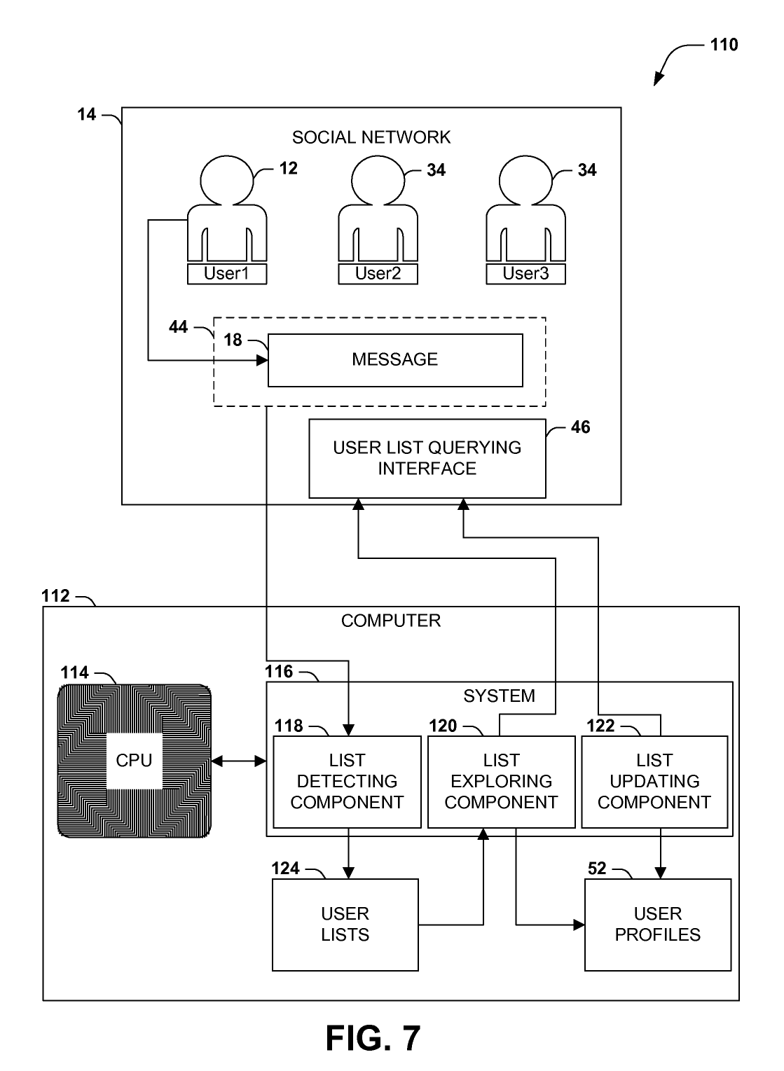

FIG. 7 presents a second embodiment of the techniques presented herein, illustrated as an exemplary scenario 110 featuring an exemplary system 116 configured to identify within a social network 14 a user list 32 comprising at least one member 34. The exemplary system 116 operates on a computer 112 having a processor 114, and may be implemented, e.g., as a software architecture, such as a set of interoperating software components comprising instructions that are stored in a volatile memory (such as system RAM) or a non-volatile memory (such as a flash memory device, a hard disk drive, a solid-state drive, or an optical disc), and that together cause the processor 114 of the computer 112 to perform the techniques presented herein. The exemplary system 116 might also be implemented, e.g., as a hardware architecture, such as a semiconductor circuit or a field-programmable memory array (FPGA), that implements the logic of the techniques presented herein. The exemplary system 116 also has access (through the computer 112, e.g., over a local area network or a wide area network) to a social network 14 having user profiles 52 of respective users 12, where at least one user 12 publishes at least one message 18. The exemplary system 116 comprises a list detecting component 118, which is configured to, upon receiving from a first user 12 a message 18, examine the message 18 to identify a list identifier 44 of a user list 32. The exemplary system 116 also comprises a list exploring component 120, which is configured to, for respective list identifiers 44 identified by the list detecting component 118, request the social network 14 to identify the members 34 of the user list 32, and, upon receiving from the social network 14 at least one member 34 of the user list 32, store in the user profile 52 of the member 34 the list identifier 44 of the user list 32. The exemplary system 116 also comprises a list updating component 122 configured to, for respective user lists 32 detected by the list detecting component 118, poll the social network 14 for updates of the user list 32, and upon receiving from the social network 14 an update of a user list 32 involving at least one second user 12, update the user profile 52 of the second user 12 regarding the update of the user list 32. In this manner, the components of the exemplary system 116 interoperate to identify user lists 32 within the social network 14 according to the techniques presented herein.

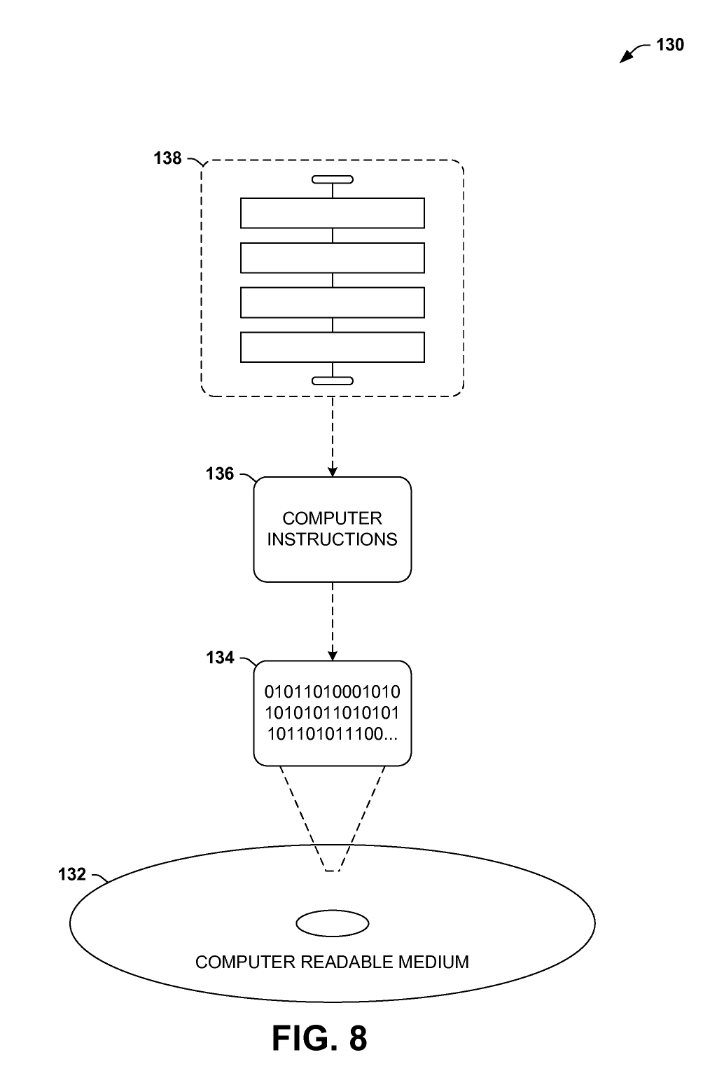

Still another embodiment involves a computer-readable medium comprising processor-executable instructions configured to apply the techniques presented herein. An exemplary computer-readable medium that may be devised in these ways is illustrated in FIG. 8, wherein the implementation 130 comprises a computer-readable medium 132 (e.g., a CD-R, DVD-R, or a platter of a hard disk drive), on which is encoded computer-readable data 134. This computer-readable data 134 in turn comprises a set of computer instructions 136 configured to operate according to the principles set forth herein. In one such embodiment, the processor-executable instructions 136 may be configured to perform a method of identifying user lists comprising at least one member within a social network having user profiles of respective users, such as the exemplary method 80 of FIG. 6. In another such embodiment, the processor-executable instructions 136 may be configured to implement a system for identifying user lists comprising at least one member within a social network having user profiles of respective users, such as the exemplary system 116 of FIG. 7. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques presented herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 80 of FIG. 6 and the exemplary system 116 of FIG. 7) to confer individual and/or synergistic advantages upon such embodiments.

A first aspect that may vary among embodiments of these techniques relates to the scenarios wherein such techniques may be utilized. As a first example, these techniques may be applied to detect user lists 32 in many types of social networks 14, such as personal social networks 14 that predominantly involve personal relationships 16 among users 12, such as family and friendship relationships 16; professional social networks 14 that predominantly promote networking among users 12 having professional relationships 16, such as colleague relationships and academic relationships; and gaming social networks 14 that predominantly involve the organization of users 12 as teams or opponents in gaming scenarios. Other social networks 14 may represent various organizations as users 12, such as a business-to-business (B2B) social network 14 that promotes connections among businesses. These social networks 14 may also promote a variety of activities among such users 12, such as posting personal information for viewing by other users 12; communications among users 12 through the exchange of messages 18, such as instant messaging or email, or by realtime voice or video communication; sharing media such as photos 20, audio such as music, and video, or other types of digital objects; providing relationship recommendations 22 in the context of networking; playing games with other users 12.

As a second example of this first aspect, many types of user lists 32 and updates thereto may be detected and monitored according to the techniques presented herein. For example, a user list 32 may comprise a one-tier set of members 34 who are related in some manner, such as belonging to a family or a group of friends, colleagues in the same organization or academic institution, or individuals sharing a characteristic, such as residence in a particular region or an avid interest in a particular hobby or profession. The updates to such a user list 32 may comprise adding a user 12 as a member to the user list 32 or removing a user 12 as a member 34 from the user list 32. Other user lists 32 may present a more complex structure, such as a multiple-tier user list 32 where some members 34 have greater rights than other members 34 (e.g., some members 34 may have administrative rights to update the user list 32 while other members 34 do not.) Still other user lists 32 may describe users 12 in various roles or as a hierarchy, such as an organizational chart (“org chart”) illustrating various superior/subordinate relationships within an institution. In addition to changes in list membership, changes to such user lists 32 may also include changes to the characteristics of one or more members 34 within the user list 32, such as a change of a member's role, position, or relationship with other members 34 of the user list 32. The user list 32 may also be configured to accept updates by any user 12 of the social network 14 (e.g., a wiki-type editing model), to allow a user 12 to alter his or her membership in the user list 32 (e.g., an opt-in mailing list model), or to allow updates only by particular members 34 of the user list 32 (such as the owner or administrator of the user list 32.)

As a third example of this first aspect, many types of devices 42 may be utilized to monitor the social network 14. In one such embodiment, a server, or a set of servers comprising a server farm, may have access to a wide range of information about the social network 14, such as an entire body of messages 18 exchanged among all users 12, and may perform broadscale monitoring of the messages 18 of all users 12 in order to detect the creation and updating of a user list 52 by any user 12 of the social network 14. Such a server or server farm may collaborate with the social network 14 to offer additional features relating to the user lists 32 of the social network 14, or may offer separate add-on services to various users 12 as an external service without the collaboration of the social network 14. In another such embodiment, a personal device 42 may be utilized to monitor the creation and updating of user lists 32 among a subset of users 12; e.g., a user 12 of the social network 14 may configure a device 42 to monitor the messages 18 of other users 12 having a relationship 16 with the user 12 to detect the creation and updating of user lists 32 by such other users 12.

As a fourth example of this first aspect, the implementation of these techniques may take many forms. FIG. 6 presents a first embodiment illustrated as an exemplary method 80 comprising a particular set of elements in a particular combination, but other embodiments may utilize different sets or combinations of elements while still implementing the techniques presented herein. Similarly, FIG. 7 presents a second embodiment illustrated as an exemplary system 116 embodying a particular architecture, but other embodiments may present different architectures, formulated as different sets or combinations of interoperating components, while still implementing the techniques presented herein.

A second aspect that may vary among embodiments of these techniques relates to the manner of polling the social network 14 for updates to a user list 32. As a first example, the device 42 may poll the social network 14 continuously for updates to the user lists 32, but this configuration may be inefficient or may overutilize the computing resources of the social network 14. As a second example, the device 42 may poll the social network 14 periodically for updates to any of the user lists 32 in series or in parallel, or may poll the social network 14 at an arbitrary rate (e.g., once per minute, select a user list 32 at random and poll the social network 14 for updates to the selected user list 32.) However, improved efficiency may be achievable by allocating the polling resources of the device 42 and/or the social network 14 to poll some user lists 32 more frequently than others. Therefore, as a third example, for respective user lists 32, the device 42 may select a polling frequency that indicates a frequency of polling the social network 14 for updates of the user list 32, and may then poll the social network 14 for updates of the user list 32 according to the selected polling frequency. In particular, it may be efficient to select the polling frequency of a user list 32 in proportion to the estimated rate of changes to the user list 32.

Many polling frequency indicators may be utilized as metrics or heuristics to estimate this rate of change and to select the polling frequency. In a first such variation, a user list 32 may be presumed to change frequently early in the life of the user list 32 while the owner of the user list 32 is devoting attention to and advertising the user list 32, but may stabilize over time into a more static user list 32. Accordingly, the polling frequency of a user list 32 may be associated with an age of the user list 32; e.g., a shorter polling frequency may be selected for newer user lists 32, and a longer polling frequency may be selected for older user lists 32. In a second such variation, the size of a user list 32 may be predictive of the rate of updates to the user list 32, and the polling frequency of the user list 32 may be selected proportionally to the number of members 34 of the user list 32. In a fourth such variation, the popularity of a user list 32 among the users 12 of the social network 14 may be associated with the polling frequency, because more popular user lists 32 may be more likely to be updated frequently by the owners thereof, and/or because stale records of the user list 32 may be visible to or may impact a greater number of users 12. Accordingly, the polling frequency of the user list 32 may be selected according to the popularity of the user list 32, which may be measured, e.g., by the popularity of at least one owner of the user list 32 (such as the user 12 who created the user list 32), a user list reference frequency (e.g., the rate at which other users 12 of the social network 14 refer to the user list 32 in messages 18), or a user list search frequency (e.g., the rate at which users 12 search for the user list 18, e.g., by querying the user list querying interface 46 of the social network 14 to identify the current members 34 of the user list 32.) In a third such variation, the rate of previous updates to a user list 32 may be used to predict the rate of future updates to a user list 32, and the polling frequency of a user list 32 may be associated with an update frequency of the user list 32. Those of ordinary skill in the art may devise many ways of polling the social network 14 for changes to the user lists 32 while implementing the techniques presented herein.

A third aspect that may vary among embodiments of these techniques relates to additional features that may be implemented regarding the social network 14 based on the detection and updating of user lists 32. These techniques may promote the implementation of many such features that might not be natively available from the social network 14. As a first example, the user list querying interface 46 of the social network 14 might be capable of enumerating the members 34 of a particular user list 18, but may not be able to enumerate the user lists 32 in which a particular user 12 is included as a member 34, as this query may involve a canvassing of all user lists 18 within the social network 14. However, a device 42 configured according to the techniques presented herein may efficiently respond to such a query by consulting the user profile 52 of the specified user 12, selecting the list identifiers 44 stored within, and presenting in response to the query the set of user lists 32 associated with the list identifiers 44 retrieved from the user profile 52. More sophisticated queries regarding list membership may also be included; e.g., the device 42 may easily execute and fulfill Boolean queries such as identifying users 12 who are members 34 of a first use list 32 and are not members of a second user list 32.

As a second example of this third aspect, the device 42 may utilize the information about user lists 32 to promote other features of the social network 14. A particular set of embodiments involve the annotation of messages 18 based on the membership of the author of the message 18 in various user lists 32, such as illustrated in the exemplary scenario 70 of FIG. 5. For example, when a user 12 posts a message 18 to the social network 14, it may be advantageous to annotate the message 18 with the list identifiers 44 of the user lists 32 in which the author of the message 18 is a member 34. Such annotation may be overt, such that when other users 12 view the message 18, the user lists 32 associated with the list identifiers 44 included in the annotation 72 are displayed, or covert, such that this information is not displayed with the message 18 to other users 12, but is available for other forms of processing. This effect may be achieved, e.g., by configuring the device 42 to, upon receiving a message 18 from a member 34 of at least one user list 32, select from the user profile 52 of the member 34 the list identifiers 44 of the user lists including the member 34, and store with the message 18 the list identifiers 44 of the user lists 32. Moreover, upon displaying the message 18 to another user 12, the user lists 32 associated with the list identifiers 44 stored with the message 18 may be identified and displayed with the message 18 (e.g., “User 3, a member of user list #David's_Colleagues, posted the following message: ‘I'm attending a conference.’”)

Additional variations of this second example may relate to updates to a user list 32 that alter the membership of a user 12, and that occur after a message 18 has been received and annotated. For example, if a user 12 is subsequently added as a member 34 to a user list 32 after posting a message 18, the annotation 72 of the message 18 may fail to include the updated user list 32. Therefore, the device 42 may be configured to, upon detecting an update comprising an adding of the user 12 as a member 34 to a user list 32, select the previous messages 18 of the user 12, and store with the previous messages 18 the list identifier 44 of the user list 32. Alternatively or additionally, if a user 12 is subsequently removed as a member 34 from a user list 32 after posting a message 18, the annotation 72 of the message 18 may incorrectly include the updated user list 32, even though the user 12 is no longer a member 34 of the user list 32. Therefore, the device 42 may be configured to, upon detecting an update comprising an removing of the user 12 as a member 34 from a user list 32, select the previous messages 18 of the user 12, and remove from the previous messages 18 the list identifier 44 of the user list 32.

As a third example of this third aspect, the device 42 may utilize the information about user lists 32 to promote the searching of messages 18 that have been posted by users 12 who are members 34 of one or more user lists 32. For example, a searching user 74 may submit a search query 76 requesting a presentation of messages 18 that include one or more search terms included in the search query 76, but that are also posted by users 12 who are members 34 of one or more user lists 32 specified in the search query 76. While the social network 14 may not be capable of fulfilling such queries in an efficient manner, the device 42 configured according to these techniques may fulfill such a search query by utilizing the information stored in the user profiles 52. For example, upon receiving from a searching user 74 a search query 76 restricted to messages 18 from the members 34 of at least one user list 32, the device 42 may first identify the list identifiers 44 of the user lists 32 specified in the search query 76 (e.g., extracting the list identifier 44 “#David's_Colleagues” from a search query 76 specified in natural language as “show messages relating to cats in #David's_Colleagues”.) The device 42 may then use the user profiles 52 to identify at least one user 12 who is included as a member 34 of the one or more user lists 32 specified in the search query 76. The device 42 may then search for matching messages that both match the search query 76 and that are from one of the members 34 of the specified user lists 32. Finally, if the device 42 identifies at least one matching message, the device 42 may present the matching messages to the searching user 74 as search results 78. The configuration of the device 42 may therefore promote the cross-referencing of the specified user lists 32 with the user profiles 52 to facilitate the execution of the search query in a manner that the social network 14 may not be natively configured to execute in an efficient manner.

As a fourth example of this third aspect, the second example (involving the annotation of messages 18 with the list identifiers 44 of user lists 32 in which the author of the message is a member 34) and the third example (involving the restriction of a search query 76 to messages 18 posted by users 12 who are members 34 of one or more specified user lists 32) may be combined to achieve even greater efficiency in the execution of such search queries. For example, if the device 42 is configured both to store with received messages 18 the list identifiers 44 of the user lists 32 that include the author of the message 18 as a member 34, and to accept search queries 76 that are restricted to messages 18 posted by users 12 who are members 34 of one or more particular user lists 32, then the device 42 may execute the search query in a more efficient manner by utilizing the annotations 72 of the messages 18. This fourth example is illustrated in the exemplary scenario 70 of FIG. 5, wherein the device 42 generates an annotation 72 of respective messages 18 upon receipt to include the list identifiers 44 of the user lists 32 in which the user 12 who posted the message 18 is included as a member 34, and also accepts from a searching user 74 a search query 76 that is to be restricted to messages 18 from the members 34 of at least one user list 32. In order to execute this search query, the device 42 may simply identify the list identifiers 44 in the search query 76, and select the matching messages 18 that both match the search query 76 and that are stored with a list identifier 44 identifying at least one of the user lists 32 specified in the search query 76. The device 42 may then present any matching messages to the searching user 74 as search results 78. For example, in the exemplary scenario 70 of FIG. 5, the device 42 receives from the searching user 74 a search query 76 including the list identifier 44 “#David's_Colleagues”, may execute the search query by searching for messages 18 that include the term of the search query 76 (“cat”) and that have an annotation 74 including the list identifier 44, and may present as search results 78 the fourth message 18 and the sixth message 18. In this manner, the list identifiers 44 specified in the search query 76 may be applied to the annotations 72 of the messages 18 in a similar manner as keywords of the search query 76 are applied to the contents of the messages 18, and the restriction may be achieved without having to reference the user lists 18 or the user profiles 52.

Additionally sophisticated versions of this fourth example may involve different ways in which the searching user 74 may specify the user lists 32 to which the search query 76 is to be restricted, and different configurations of the device 42 to support such alternatively specified search queries 76. As a first variation, illustrated in the exemplary scenario 70 of FIG. 5, the searching user 74 may specify the user lists 32 according to the list identifiers 44 thereof (e.g., including “#David's_Colleagues” to limit the search to the user list 32 comprising the colleagues of the user 12 who created the user list 32.) As a second variation, the search query 76 may specify the restriction of the search query 76 to all user lists 32 that include the searching user 74 as a member 34; e.g., the search query 76 is restricted to messages 18 posted by users 12 who are included as members 34 in any user list 32 that also includes the searching user 74. (This definition naturally includes all messages posted by the searching user 74, but the searching user 74 may or may not be interested in viewing his or her own messages 18 that match the search query 76; accordingly, messages 18 posted by the searching user 74 may either be included or excluded in this search.) This search query 76 may be executed by referencing the user profile 52 of the searching user 74 to identify the list identifiers 44 associated with the searching user 74, and by searching for matching messages 18 that both include content matching the terms of the search query 76 and that include one or more of the list identifiers 44 retrieved from the user profile 52 of the searching user 74.

As a third variation, the search query 76 may specify the restriction of the search query 76 to all user lists 32 that include another specific user 12 as a member 34; e.g., the search query 76 is restricted to messages 18 posted by users 12 who are included as members 34 in any user list 32 that also includes the user 12 specified in the search query 76. For example, a first user 12 may have a friendship relationship 16 with a second user 12, and may wish to search for any messages 18 posted by any member 34 of the user lists 32 including the second user 12 that include a particular keyword. This search query 76 may be executed by referencing the user profile 52 of the searching user 74 to identify the list identifiers 44 associated with the second user 12, and by searching for matching messages 18 that both include content matching the terms of the search query 76 and that include one or more of the list identifiers 44 retrieved from the user profile 52 of the second user 12. These and other features related to the tracking of user lists 32 of the social network 14 may be implemented by those of ordinary skill in the art according to the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

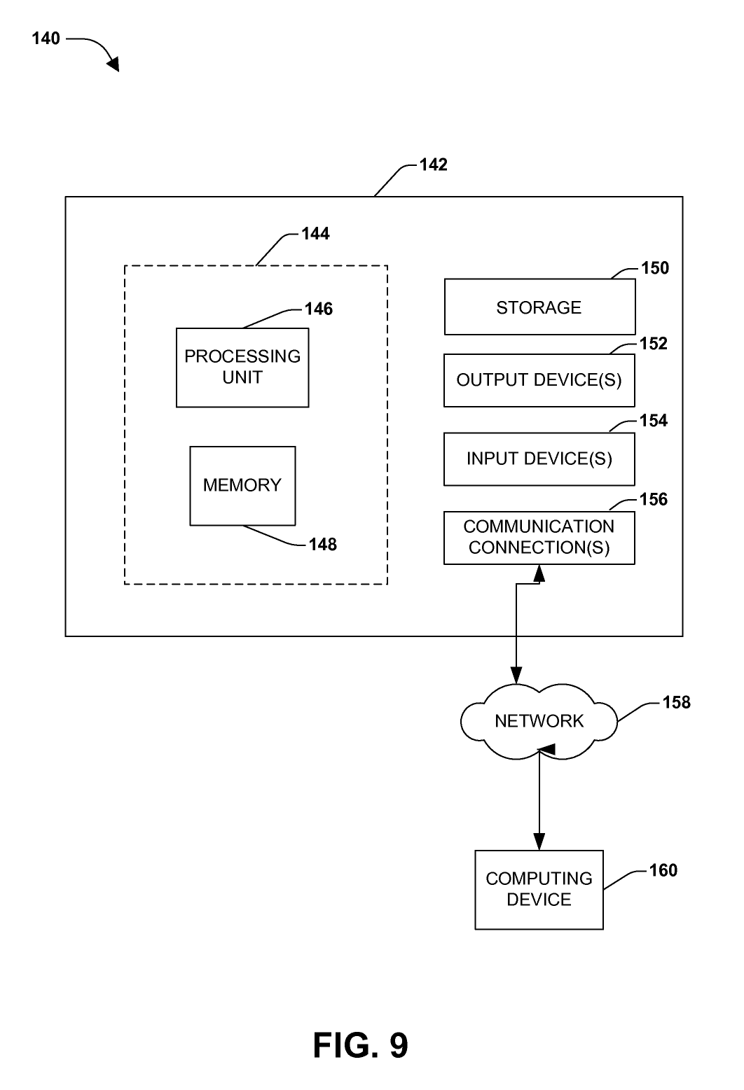

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (presented herein). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 140 comprising a computing device 142 configured to implement one or more embodiments provided herein. In one configuration, computing device 142 includes at least one processing unit 146 and memory 148. Depending on the exact configuration and type of computing device, memory 148 may be volatile (such as RAM, for example), non-volatile (such as ROM, flash memory, etc., for example) or some combination of the two. This configuration is illustrated in FIG. 9 by dashed line 144.

In other embodiments, device 142 may include additional features and/or functionality. For example, device 142 may also include additional storage (e.g., removable and/or non-removable) including, but not limited to, magnetic storage, optical storage, and the like. Such additional storage is illustrated in FIG. 9 by storage 150. In one embodiment, computer readable instructions to implement one or more embodiments provided herein may be in storage 150. Storage 150 may also store other computer readable instructions to implement an operating system, an application program, and the like. Computer readable instructions may be loaded in memory 148 for execution by processing unit 146, for example.

The term “computer readable media” as used herein includes computer storage media. Computer storage media includes volatile and nonvolatile, removable and non-removable media implemented in any method or technology for storage of information such as computer readable instructions or other data. Memory 148 and storage 150 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 142. Any such computer storage media may be part of device 142.

Device 142 may also include communication connection(s) 156 that allows device 142 to communicate with other devices. Communication connection(s) 156 may include, but is not limited to, a modem, a Network Interface Card (NIC), an integrated network interface, a radio frequency transmitter/receiver, an infrared port, a USB connection, or other interfaces for connecting computing device 142 to other computing devices. Communication connection(s) 156 may include a wired connection or a wireless connection. Communication connection(s) 156 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 142 may include input device(s) 154 such as keyboard, mouse, pen, voice input device, touch input device, infrared cameras, video input devices, and/or any other input device. Output device(s) 152 such as one or more displays, speakers, printers, and/or any other output device may also be included in device 142. Input device(s) 154 and output device(s) 152 may be connected to device 142 via a wired connection, wireless connection, or any combination thereof. In one embodiment, an input device or an output device from another computing device may be used as input device(s) 154 or output device(s) 152 for computing device 142.

Components of computing device 142 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 142 may be interconnected by a network. For example, memory 148 may be comprised of multiple physical memory units located in different physical locations interconnected by a network.

Those skilled in the art will realize that storage devices utilized to store computer readable instructions may be distributed across a network. For example, a computing device 160 accessible via network 158 may store computer readable instructions to implement one or more embodiments provided herein. Computing device 142 may access computing device 160 and download a part or all of the computer readable instructions for execution. Alternatively, computing device 142 may download pieces of the computer readable instructions, as needed, or some instructions may be executed at computing device 142 and some at computing device 160.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of identifying, within a social network having user profiles of respective users, where at least one user publishes at least one message, a user list comprising at least one member, the method performed on a device having a processor and comprising:
executing on the processor instructions configured to:
upon receiving from a first user a message:
examine the message to identify a list identifier of a user list, and
upon identifying a list identifier:
request the social network to identify the members of the user list, and
upon receiving from the social network at least one member of the user list, store in the user profile of the member the list identifier of the user list; and
for respective user lists:
poll the social network for updates of the user list, and
upon receiving from the social network an update of a user list involving at least one second user, update the user profile of the second user regarding the update of the user list.

2. The method of claim 1:
at least one update of a user list comprising removing the second user as a member from the user list; and
updating the user profile of the second user comprising: removing the list identifier of the user list from the user profile of the second user.

3. The method of claim 1, polling the social network for updates of a user list comprising:
selecting a polling frequency indicating a frequency of polling the social network for updates of the user list; and
polling the social network for updates of the user list according to the polling frequency of the user list.

4. The method of claim 3, the polling frequency of a user list associated with an age of the user list.

5. The method of claim 3, the polling frequency of the user list associated with an update frequency of the user list.

6. The method of claim 3, the polling frequency of a user list associated with a popularity of the user list.

7. The method of claim 6, the popularity of the user list identified according to a popularity of at least one owner of the user list.

8. The method of claim 6, the popularity of the user list identified according to a user list reference frequency to the user list by users of the social network.

9. The method of claim 6, the popularity of the user list identified according to a user list search frequency for the user list by users of the social network.

10. The method of claim 1, the instructions configured to, upon receiving from a searching user a search query restricted to messages from the members of at least one user list:
based on the user profiles, identify at least one user included as a member of the at least one user list;
select at least one matching message that matches the search query and from the at least one member; and
upon identifying at least one matching message, present the at least one matching message to the searching user as a search result of the search query.

11. The method of claim 1, the instructions configured to, upon receiving a second message from a member of at least one user list:
from the user profile of the member, select the list identifiers of at least one user list including the member; and
store with the second message the list identifiers of the at least one user list.

12. The method of claim 11, the instructions configured to, upon presenting the second message to a third user, present to the third user with the second message the at least one list identifier stored with the second message.

13. The method of claim 11, the instructions configured to, upon detecting an update comprising an adding of the second user as a member to a user list:
select at least one previous message from the second user, and
store with the at least one previous message the list identifiers of the at least one user list.

14. The method of claim 11, the instructions configured to, upon detecting an update comprising a removing of the second user as a member from a user list:
select at least one previous message from the second user, and
remove from the at least one previous message the list identifiers of the at least one user list.

15. The method of claim 11, the instructions configured to, upon receiving from a searching user a search query restricted to messages from the members of at least one user list:
select at least one matching message that matches the search query and that is stored with a list identifier identifying at least one user list specified in the search query, and
upon identifying at least one matching message, present the at least one matching message to the searching user as a search result of the search query.

16. The method of claim 15:
at least one user list specified by the search query according to a list identifier; and
selecting the at least one matching message comprising: selecting at least one matching message that matches the search query and that is stored with a list identifier matching at least one list identifier specified in the search query.

17. The method of claim 15, the user lists specified by the search query comprising at least one user list including the searching user as a member.

18. The method of claim 15:
at least one user list specified by the search query according to the user lists including as a member at least one fourth user specified in the user query; and
selecting the at least one matching message comprising: selecting at least one matching message that matches the search query and that is stored with a list identifier identifying at least one user list specifying the at least one fourth user as a member.

19. A system having access to a social network having user profiles of respective users, where at least one user publishes at least one message, and the system configured to identify within the social network a user list comprising at least one member, the system comprising:
a list detecting component configured to, upon receiving from a first user a message, examine the message to identify a list identifier of a user list;
a list exploring component configured to, for respective list identifiers identified by the list detecting component:
request the social network to identify the members of the user list, and
upon receiving from the social network at least one member of the user list, store in the user profile of the member the list identifier of the user list; and
a list updating component configured to, for respective user lists:
poll the social network for updates of the user list, and
upon receiving from the social network an update of a user list involving at least one second user, update the user profile of the second user regarding the update of the user list.

20. A computer-readable storage medium comprising instructions that, when executed on a processor of a device having access to a social network having user profiles of respective users, where at least one user publishes at least one message, identify at least one user list comprising at least one member by:
upon receiving from a first user a message:
examining the message to identify a list identifier of a user list, and
upon identifying a list identifier:
requesting the social network to identify the members of the user list, and
upon receiving from the social network at least one member of the user list, storing in the user profile of the member the list identifier of the user list; and
for respective user lists:
polling the social network for updates of the user list by:
selecting a polling frequency indicating a frequency of polling the social network for updates of the user list, the polling frequency associated with at least one polling frequency indicator selected from a set of polling frequency indicators comprising:
an age of the user list;
a popularity of at least one owner of the user list;
a user list reference frequency to the user list by users of the social network;
a user list search frequency to the user list by users of the social network; and
an update frequency of the user list; and
polling the social network for updates of the user list according to the polling frequency of the user list;
upon receiving from the social network an update of a user list involving at least one second user, updating the user profile of the second user regarding the update of the user list;
upon receiving a second message from a member of at least one user list:
from the user profile of the member, selecting the list identifiers of at least one user list including the member; and
storing with the second message the list identifiers of the at least one user list;
upon presenting the second message to a third user, presenting to the third user with the second message the at least one list identifier stored with the second message;
upon detecting an update comprising an adding of the second user as a member to a user list:
selecting at least one previous message from the second user, and
storing with the at least one previous message the list identifiers of the at least one user list;
upon detecting an update comprising a removing of the second user as a member from a user list:
selecting at least one previous message from the second user, and
removing from the at least one previous message the list identifiers of the at least one user list; and
upon receiving from a searching user a search query restricted to messages from the members of at least one user list:
selecting at least one matching message that matches the search query and that is stored with a list identifier identifying at least one user list specified in the search query, and
upon identifying at least one matching message, presenting the at least one matching message to the searching user as a search result of the search query.
